(19) United States
(12) Patent Application Publication
(10) Pub. No.: US 2020/0192480 A1
(43) Pub. Date: Jun. 18, 2020

(54) SYSTEMS AND METHODS FOR PROVIDING HAPTIC EFFECTS BASED ON A USER'S MOTION OR ENVIRONMENT

(71) Applicant: Immersion Corporation, San Jose, CA (US)

(72) Inventors: Juan Manuel Cruz Hernandez, Westmount (CA); Robert W. Heubel, San Leandro, CA (US)

(73) Assignee: Immersion Corporation, San Jose, CA (US)

(21) Appl. No.: 16/224,242

(22) Filed: Dec. 18, 2018

(51) Int. Cl. G06F 3/01

(52) U.S. Cl. CPC G06F 3/016; G06F 3/017

(57) ABSTRACT

One illustrative system disclosed herein includes a system that comprises a sensor, a memory, and a processor in communication with each of these elements. The sensor can capture information about a user's motion or environment at a point in time associated with a content and transmit a signal about the captured user motion or environment to the processor. The processor determines a haptic effect associated with the detected user motion or environment. The processor can also transmit a haptic signal associated with the haptic effect to be output at the particular time during output of the content. The illustrative system also includes a haptic output device configured to receive the haptic signal and output the haptic effect.

### FIELD OF INVENTION

The present disclosure relates generally to user interface devices. More specifically, but not by way of limitation, this disclosure relates to capturing information about a user's motion or the user's environment and providing haptic effects based on the user's motion or environment.

### BACKGROUND

Display devices can be used to provide content, such as videos or a simulated environment (e.g., a virtual or an augmented reality environment). Many modern user interface devices can be used to provide haptic feedback to the user as the content is provided to the user or as the user interacts with the content.

Many user interface devices or feedback systems, however, may lack the capability of providing haptic feedback that corresponds to the content provided to the user or haptic feedback that varies over time (e.g., varies over time in accordance with the content provided to the user). Moreover, developing or designing haptic effects may require expertise, may be time consuming, or can cause haptic effects to be undesirably or inaccurately associated with the particular content provided to the user.

### SUMMARY

Various embodiments of the present disclosure provide systems and methods for capturing information about a user's motion or the user's environment and providing haptic effects based on the user's motion or environment.

In one embodiment, a system comprises a first sensor configured to capture a motion of a first user and a processor communicatively coupled to the first sensor. The processor is configured to receive, from the first sensor, a first sensor signal indicating the motion of the first user at a time in the content; determine a first haptic effect associated with the motion of the first user; and transmit a first haptic signal associated with the first haptic effect to be output at the time when the content is output. The system further comprises a haptic output device configured to receive the first haptic signal and output the first haptic effect.

In another embodiment, a system comprises a first sensor configured to capture information indicating a motion of a first user's body part and a second sensor configured to capture information indicating a motion of a second user's body part. The system further comprises a processor communicatively coupled to the first sensor and the second sensor. The processor is configured to receive, from the first sensor, a first sensor signal indicating the motion of the first user's body part; determine a first haptic effect associated with the motion of the first user's body part; receive, from the second sensor, a second sensor signal indicating the motion of the second user's body part; determine a characteristic of the first haptic effect based on the motion of the second user's body part; and transmit a haptic signal associated with the first haptic effect. The system also comprises a haptic output device configured to receive the haptic signal and output the first haptic effect.

In other embodiments, computer-implemented methods comprise the steps performed by these systems.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a block diagram showing a system for capturing information about a user's motion or the user's environment and providing haptic effects based on the user's motion or environment according to one embodiment.

FIG. 2 is a flow chart of steps for performing a method for capturing information about a user's motion or the user's environment and providing haptic effects based on the user's motion or environment according to one embodiment.

FIG. 3 is a flow chart of steps for performing a method for capturing information about a user's motion and providing haptic effects based on the user's motion according to another embodiment.

### DETAILED DESCRIPTION

Reference now will be made in detail to various and alternative illustrative embodiments and to the accompanying drawings. Each example is provided by way of explanation and not as a limitation. It will be apparent to those skilled in the art that modifications and variations can be made. For instance, features illustrated or described as part of one embodiment may be used in another embodiment to yield a still further embodiment. Thus, it is intended that this disclosure includes modifications and variations that come within the scope of the appended claims and their equivalents.

### Illustrative Examples of Capturing Information about a User's Motion or Environment and Providing Haptic Effects Based on the User's Motion or Environment

One illustrative embodiment of the present disclosure comprises a computing device, such as a wearable device. The computing device comprises a sensor, a memory, and a processor in communication with each of these elements.

In the illustrative embodiment, the sensor can capture motion of a user of the computing device (e.g., a motion of the user's body part). For example, the sensor can be an accelerometer and/or other sensor that can detect, monitor, or otherwise capture information about a motion of the user's body part. The sensor can also capture information about the user's environment. The sensor can transmit a signal indicating the captured information to a database for storing data about the user motion and/or environment. The sensor can also transmit a signal about the captured information to the processor, which determines a haptic effect based at least in part on the detected user motion or the information about the user's environment. In some examples, the processor can transmit data about the haptic effect associated with the user's motion or the user's environment to the database for storing.

As an example the sensor detects various motions by the user including for example, when the user moves a hand up, runs and then stops, signals a high five, jumps, turns the user's head, etc. In this example, the sensor can transmit one or more sensor signals indicating each detected user motion to the memory, which can store data about the detected motions in the database. The sensor can also transmit various sensor signals indicating each detected user motion to the processor and the processor can determine one or more haptic effects associated with each detected user motion. For instance, the processor can determine a first haptic effect associated with the user jumping and a second haptic effect associated with the user turning the user's head. The processor can transmit data indicating a haptic effect associated with a particular user motion to the memory, which can store the data in the database.

In the illustrative embodiment, the processor can transmit a haptic signal associated with the determined haptic effect to a haptic output device associated with the user or another user (e.g., to a smartwatch worn by the user or the other user that includes the haptic output device) in response to determining a haptic effect associated with a user's motion or environment. The haptic output device is configured to receive the haptic signal from the processor and output one or more haptic effects based on the haptic signal. In the illustrative embodiment, the haptic effects can correspond to the detected user motion or the user's environment, which can allow either a first user or a second user to perceive haptic effects that correspond to the detected motions of the user.

For example, the sensor can detect various motions of a first user and transmit signals to the processor, which can determine various haptic effects associated with the detected motions. In this example, the processor can transmit haptic signals associated with the haptic effects to a haptic output device associated with the first user or a second user in response to determining a haptic effect associated with a detected motion of the first user. The haptic output device is configured to receive the haptic signal from the processor and output, to either the first or second user, one or more haptic effects associated with the detected motion of the first user. In this manner, haptic effects can be output such that a user can perceive haptic effects that correspond to the user's detected motion or haptic effects can be output such that a user can perceive haptic effects that correspond to another user's motion. In some embodiments, the haptic output device is configured to receive the haptic signal in substantially real time (e.g., as the sensor detects the first user's motion) such that the haptic output device can output the haptic effect in substantially real time. In another embodiment, the haptic effects associated with the first user's motions can be determined and stored to be output subsequently. In some embodiments, the haptic output device is configured to receive one or more haptic signals associated with a first user's motion associated with a particular time in some form of content, such as a video or virtual or augmented reality sequence, and output one or more haptics effect associated with the first user's motion at the particular time to a second user as the second user is viewing or otherwise experiencing the content that includes the first user's motion.

In some embodiments, the haptic output device can output a haptic effect to a user at a location that corresponds to a location of a detected user motion. For instance, the sensor can detect or sense that a first user is clapping and transmit signals to the processor, which can determine a haptic effect associated with the first user clapping. In this example, the processor can transmit haptic signals associated with the haptic effects to a haptic output device associated with a second user. The haptic output device can receive the haptic signals from the processor and output, to the second user, one or more haptic effects associated with the first user clapping at a corresponding location (e.g., output the haptic effects to the second user's hands).

In the illustrative embodiment, the sensor can detect a user's motions or information about the user's environment over a period of time and transmit one or more signals to the processor indicating the detected user motions or environmental conditions and the processor can determine one or more haptic effects associated with the various user motions or environmental conditions over the period of time. In some examples, the processor receives signals from the sensor indicating a time stamp corresponding to a time that each user motion or condition of the user's environment is detected and the processor determines a timeline (e.g., an order) of the various user motions or environmental conditions over the period of time. In this example, the processor can determine a haptic effect associated with each detected user motion or environmental condition in the timeline and transmit a haptic signal associated with each haptic effect to the haptic output device. In this example, the haptic output device can output the haptic effects to one or more users such that the user perceives the haptic effects based on the timeline. For instance, the haptic output device can output the haptic effects to a user such that the user perceives a haptic effect associated with another user's motion or environment in the order of the other user's motions or detected environmental conditions in the timeline.

As an illustrative example, a first user is climbing a mountain and wearing a sensor that captures information about the first user's motion, activity, or any information about the first user's environment. The sensor can transmit various sensor signals about the first user's motion, activity, or environment to a processor that determines one or more haptic effects based on the sensor signals. In this example, the processor can transmit haptic signals to a haptic output device associated with a second user that is remote from the first user (e.g., to a smartwatch worn by the second user that includes the haptic output device). In this illustrative example, the second user can be watching content (e.g., a video) that includes the first user as the first user climbs the mountain (e.g., watching in real time or at any other time) and the haptic output device can output one or more haptic effects, which can allow the second user to perceive or experience the first user's motion, activity, or environment as the first user climbs the mountain.

In some embodiments, a user perceiving haptic effects that correspond to detected user motions can provide user input to modify the haptic effects. For instance, the user can provide user input to modify a characteristic (e.g., a magnitude, duration, location, type, frequency, etc.) of the haptic effect. As an example, the user can perceive a haptic effect associated with a detected user motion such as, for example, via a computing device held by the user that includes a haptic output device that outputs the haptic effect. In the illustrative embodiment, the user can be wearing a smartwatch that includes a sensor for detecting or sensing a motion (e.g., gesture) by the user and the user's motion can be used to modify a characteristic of the haptic effect. For instance, the user can perceive the haptic effect via the computing device and raise a hand (e.g., the hand on which the user is wearing the smartwatch) and the sensor of the smartwatch can detect the user's motion. In this example, the sensor can transmit a signal indicating the detected motion to a processor, which can modify a characteristic of the haptic effect based on the detected motion such as, for example, by increasing a magnitude of the haptic effect in response to determining that the user is raising the hand.

In this manner, the systems and methods described herein can capture a user's motions and generate or modify a haptic effect based on the captured motion.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Illustrative Examples of a System for Capturing a User's Motion and Providing Haptic Effects Based on the Captured Motion

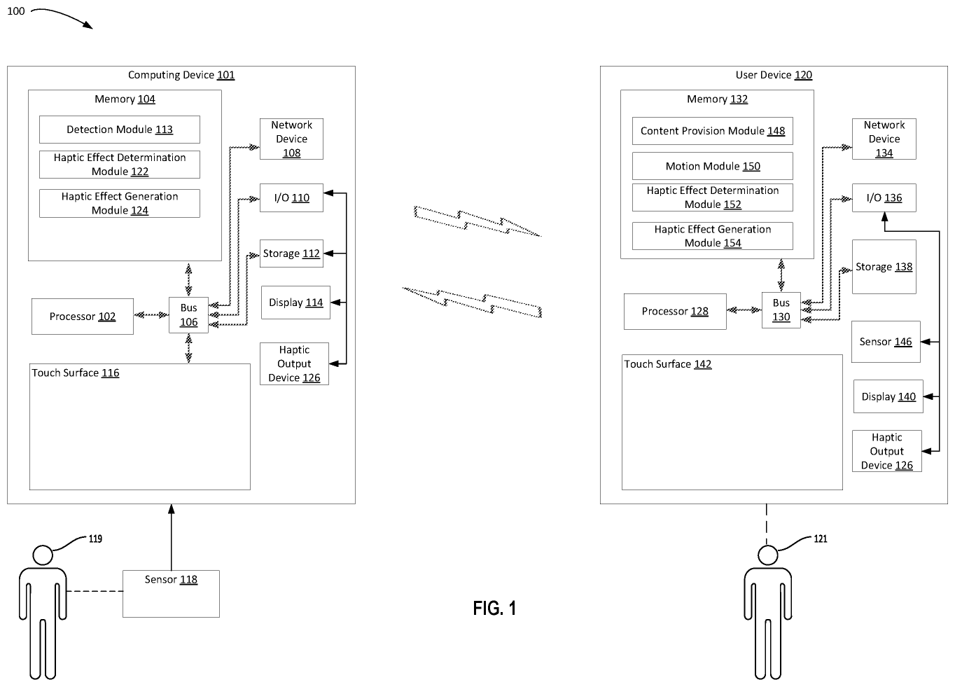

FIG. 1 is a block diagram showing a system 100 for capturing information about a user's motion or the user's environment and providing haptic effects based on the user's motion or environment according to one embodiment. In the embodiment depicted in FIG. 1, the system 100 comprises a computing device 101 having a processor 102 in communication with other hardware via a bus 106. The computing device 101 may comprise, for example, a personal computer, a mobile device (e.g., a smartphone), tablet, smartwatch, a wearable device, etc. In some embodiments, the computing device 101 may include all or some of the components depicted in FIG. 1.

A memory 104, which can comprise any suitable tangible (and non-transitory) computer-readable medium such as random access memory (“RAM”), read-only memory (“ROM”), erasable and programmable read-only memory (“EEPROM”), or the like, embodies program components that configure operation of the computing device 101. In the embodiment shown, computing device 101 further includes one or more network interface devices 108, input/output (I/O) interface components 110, and storage 112.

Network interface device 108 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

I/O components 110 may be used to facilitate wired or wireless connections to devices such as one or more displays 114, game controllers, keyboards, mice, joysticks, cameras, buttons, speakers, microphones and/or other hardware used to input or output data. Storage 112 represents nonvolatile storage such as magnetic, optical, or other storage media included in computing device 101 or coupled to the processor 102.

In some embodiments, the computing device 101 includes a touch surface 116 (e.g., a touchpad or touch sensitive surface) that can be communicatively connected to the bus 106 and configured to sense tactile input of a user. While in this example, the computing device 101 includes a touch surface 116 that is described as being configured to sense tactile input of a user, the present disclosure is not limited to such configurations. Rather, in other examples, the computing device 101 can include the touch surface 116 and/or any surface that may not be configured to sense tactile input.

The system 100 further comprises a sensor 118. In some embodiments, the sensor 118 may comprise, for example, gyroscope, an accelerometer, imaging sensor, a camera, magnetometer, microphone, temperature sensor, force sensor, pressure sensor, heart rate sensor, pulse sensor, an inertial measurement unit, an electroencephalogram, and/or other sensor that can detect, monitor, or otherwise capture information about a user's motion (e.g., gesture) or the user's environment. For example, the sensor 118 can be a wearable sensor, a handheld sensor, or any sensor that can be coupled (e.g., attached) to a user 119 or otherwise associated with the user 119 to capture motion of the user 119 (e.g., a motion of the user's body part) or capture information about the environment of the user 119. In some embodiments, the sensor 118 can transmit one or more sensor signals to the computing device 101 that indicate information about motion of the user 119 or about the user's environment.

Turning to memory 104, modules 113, 122, and 124 are depicted to show how a device can be configured in some embodiments to capture information about a user's motion or about the user's environment and provide haptic effects based on the user's motion or environment. In some embodiments, modules 113, 122, and 124 may comprise processor executable instructions that can configure the processor 102 to perform one or more operations.

For example, a detection module 113 can configure the processor 102 to receive sensor signals from the sensor 118. As an example, the detection module 113 may cause the processor 102 to receive a sensor signal from the sensor 118 when the sensor 118 detects or senses a motion of the user 119 or captures information about the environment of the user 119. In some examples, the sensor signal from the sensor 118 can include information about the user's motion including, but not limited to, a path, velocity, acceleration, force, etc. of the user's motion, a body part of the user 119 that is moved, and/or any other characteristic of the motion of the user 119. In some examples, the sensor signal from the sensor 118 can include information about a parameter (e.g., condition) of the environment of the user 119 including, but not limited to, a temperature, humidity, latitude, etc. of the user's environment. In some examples, the processor 102 can receive one or more sensor signals from the sensor 118 and determine information about the user's motion or about the user's environment based on the sensor signals.

In some embodiments, the haptic effect determination module 122 represents a program component that analyzes data to determine a haptic effect to generate. The haptic effect determination module 122 may comprise code that causes the processor 102 to select one or more haptic effects to output using one or more algorithms or lookup tables. In some embodiments, the haptic effect determination module 122 comprises one or more algorithms or lookup tables usable by the processor 102 to determine a haptic effect.

Particularly, in some embodiments, the haptic effect determination module 122 may cause the processor 102 to determine a haptic effect based at least in part on sensor signals received from the sensor 118. For example, the sensor 118 may detect a motion of a body part of the user 119 associated with the sensor 118 (e.g., a user 119 that is holding or wearing the sensor 118) and transmit a sensor signal to the processor 102. The processor 102 may receive the sensor signal and determine the motion of the user 119 and/or a characteristic of the motion. The haptic effect determination module 122 may cause the processor 102 to determine a haptic effect based at least in part on the determined user motion and/or characteristic of the motion. As another example, the sensor 118 may capture information about the environment of the user 119 and transmit a sensor signal to the processor 102 that determines information about the user's environment based on the sensor signal. In this example, the haptic effect determination module 122 can include instructions that, when executed by the processor 102, cause the processor 102 to determine a haptic effect based at least in part on the determined information about the user's environment.

For example, in one embodiment, the haptic effect determination module 122 may cause the processor 102 to access one or more lookup tables or databases that include data corresponding to various haptic effects associated with various user motions or gestures. The haptic effect determination module 122 may also cause the processor 102 to access one or more lookup tables or databases that include data corresponding to various haptic effects associated with various characteristics of a user's motion or gesture. In this embodiment, the processor 102 can access the one or more lookup tables or databases and select one or more haptic effects associated with the user's motion or gesture and/or characteristic of the motion. As an example, the processor 102 can determine that the user 119 is moving a hand, is running, signaling a high five, jumping, etc. Based on this determination, the processor 102 can select a haptic effect associated with each detected user motion. In some examples, the haptic effect may allow the user 119 or another user 121 to perceive or experience haptic effects that correspond to a detected motion. For instance, if the user 119 is jumping up and down, the haptic effect can include a vibration or a series of vibrations that can allow the user 119 or another user 121 to perceive the user 119 jumping up and down.

In some embodiments, the haptic effect determination module 122 may cause the processor 102 to determine a haptic effect associated with a simulated motion of a user's body part. For instance, the user 119 may not move a body part and the processor 102 may receive or determine data indicating a simulated motion of the user's body part or a characteristic of the simulated motion. For example, the processor 102 can receive (e.g., obtain) data indicating simulated force, velocity, or acceleration parameters associated with the user 119 jumping up and down. In this example, the parameters can be based on historical data obtained from a person jumping up and down or a simulation of a person jumping up and down. In this example, the processor 102 can determine one or more haptic effects associated with the simulated motion of the user's body part in substantially the same manner as described above.

As another example, the haptic effect determination module 122 may cause the processor 102 to access one or more lookup tables or databases that include data corresponding to various haptic effects associated with various environmental conditions. In this embodiment, the processor 102 can access the one or more lookup tables or databases and select one or more haptic effects associated with the environment of the user 119. As an example, the processor 102 can determine that the user 119 is in an environment with a heavy (e.g., strong) wind. Based on this determination, the processor 102 can select a haptic effect associated with the user's environment. In some examples, the haptic effect may allow a user (e.g., the user 119 or the user 121) to perceive or experience haptic effects that correspond with the detected environmental conditions. For instance, if the user 119 is in an environment with heavy winds, the haptic effect can include a strong or long vibration or series of vibrations that can allow the user 119 or another user 121 to perceive the heavy winds.

In some embodiments, the haptic effect determination module 122 may cause the processor 102 to determine a haptic effect associated with a simulated environment with which the user 119 is interacting. For instance, the user 119 may be in, or interact with, a simulated environment (e.g., a virtual or augmented reality environment) and the conditions of the simulated environment may be different from the conditions of the user's physical environment (e.g., a room in which the user 119 is positioned). In this example, the processor 102 can receive data indicating parameters (e.g., characteristics) or conditions of the simulated environment and the processor 102 can determine one or more haptic effects associated with the parameters or conditions of the simulated environment in substantially the same manner as described above (e.g., by selecting a haptic effect from a database that includes various haptic effects associated with various conditions of a simulated environment).

The processor 102 may also determine a user's motion (e.g., gesture) and/or a characteristic of the motion and determine a characteristic (e.g., a magnitude, duration, location, type, frequency, etc.) of the haptic effect based on the motion and/or characteristic of the motion. For example, the haptic effect determination module 122 may cause the processor 102 to access one or more lookup tables or databases that include data corresponding to a characteristic of a haptic effect associated with a user's motion and/or characteristic of the motion. In this embodiment, the processor 102 can access the one or more lookup tables or databases and determine a characteristic of one or more haptic effects associated with the user's motion or gesture and/or characteristic of the motion. For instance, if the user 119 is running at a fast pace, the haptic effect can include a strong vibration or a series of strong vibrations that can allow the user 119 or another user 121 to perceive the user 119 running at a fast pace.

In additional or alternative embodiments, the processor 102 can also determine information about a user's environment or simulated environment and determine a characteristic of the haptic effect based on the information about the user's environment. For example, if the user 119 is in an environment with light rainfall, the haptic effect can include a weak vibration or a series of weak vibrations that can allow the user 119 or another user 121 to perceive the user 119 being in an environment with light rainfall. In determining a characteristic, the processor 102 may modify characteristics of the haptic effect or may generate a new haptic effect to augment the original haptic effect.

In some embodiments, the haptic effect generation module 124 represents programming that causes the processor 102 to generate and transmit haptic signals to a haptic output device (e.g., the haptic output device 126 of the user device 120, computing device 101, or another haptic output device) to generate the selected haptic effect. In some embodiments, the haptic effect generation module 124 causes the haptic output device to generate a haptic effect determined by the haptic effect determination module 122. For example, the haptic effect generation module 124 may access stored waveforms or commands to send to the haptic output device to create the selected haptic effect. For example, the haptic effect generation module 124 may cause the processor 102 to access a lookup table that includes data indicating one or more haptic signals associated with one or more haptic effects and determine a waveform to transmit to the haptic output device to generate a particular haptic effect. In some embodiments, the haptic effect generation module 124 may comprise algorithms to determine the haptic signal. The haptic effect generation module 124 may comprise algorithms to determine target coordinates for the haptic effect (e.g., coordinates for a location at which to output the haptic effect). For example, the haptic effect generation module 124 may cause the processor 102 to use a sensor signal indicating a motion of a particular body part of the user 119 to determine target coordinates for the haptic effect (e.g., a corresponding body part of another user 121). In some embodiments, the processor 102 can transmit a haptic signal to a haptic output device that includes one or more haptic output devices. In such embodiments, the haptic effect generation module 124 may cause the processor 102 to transmit haptic signals to the one or more haptic output devices to generate the selected haptic effect.

In some embodiments, the haptic output device 126 of the user device 120, the computing device 101, or any other device can receive a haptic signal from the processor 102 and output one or more haptic effects. For instance, the haptic output device 126 can output a haptic effect associated with motions or gestures of the user 119 or an environment of the user 119.

The user device 120 can be, for example, a mobile device (e.g., a smartphone), e-reader, smartwatch, a head-mounted display, glasses, a wearable device, a handheld device (e.g., a tablet, video game controller), or any other type of user interface device.

The user device 120 can include a processor 128 in communication with other hardware via a bus 130. The user device 120 can also include a memory 132, network interface device 134, I/O components 136, storage 138, display 140, and a touch surface 142 each of which can be configured in substantially the same manner as the memory 104, network interface device 108, I/O components 110, storage 112, display 114, and touch surface 116 respectively, although they need not be.

In some embodiments, the user device 120 comprises a touch-enabled display that combines the touch surface 142 and the display 140 of the user device 120. The touch surface 142 may be overlaid on the display 140, may be the display 140 exterior, or may be one or more layers of material above components of the display 140. In other embodiments, the user device 120 may display a graphical user interface (“GUI”) that includes one or more virtual user interface components (e.g., buttons) on the touch-enabled display and the touch surface 142 can allow interaction with the virtual user interface components.

In some embodiments, the user device 120 comprises one or more sensors 146. In some embodiments, the sensor 146 can be configured in substantially the same manner as the sensor 118, although it need not be. For example, the sensor 146 can detect, sense, or otherwise capture information about a motion or gesture of a user of the user device 120 (e.g., the user 121).

In some embodiments, the haptic output device 126 is in communication with the processor 128 and/or the processor 102 and the haptic output device 126 is configured to output a haptic effect in response to a haptic signal from the processor 102 or the processor 128. In some embodiments, the haptic output device 126 is configured to output a haptic effect comprising, for example, a vibration, a squeeze, a poke, a change in a perceived coefficient of friction, a simulated texture, a stroking sensation, an electro-tactile effect, a surface deformation (e.g., a deformation of a surface associated with the user device 120), and/or a puff of a solid, liquid, or gas. Further, some haptic effects may use multiple haptic output devices 126 of the same or different types in sequence and/or in concert. Although a single haptic output device 126 is shown in FIG. 1, some embodiments may use multiple haptic output devices 126 of the same or different type to produce haptic effects.

In some embodiments, the haptic output device 126 is in communication with the processor 128 or the processor 102 and internal to the user device 120. In other embodiments, the haptic output device 126 is external to the user device 120 and in communication with the user device 120 or computing device 101 (e.g., via wired interfaces such as Ethernet, USB, IEEE 1394, and/or wireless interfaces such as IEEE 802.11, Bluetooth, or radio interfaces). For example, the haptic output device 126 may be associated with (e.g., coupled to) a wearable device (e.g., a wristband, bracelet, hat, headband, etc.) and configured to receive haptic signals from the processor 128 or the processor 102.

In some embodiments, the haptic output device 126 is configured to output a haptic effect comprising a vibration. The haptic output device 126 may comprise, for example, one or more of a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

In some embodiments, the haptic output device 126 is configured to output a haptic effect modulating the perceived coefficient of friction of a surface associated with the user device 120 (e.g., the touch surface 142). In one embodiment, the haptic output device 126 comprises an ultrasonic actuator. An ultrasonic actuator may vibrate at an ultrasonic frequency, for example 20 kHz, increasing or reducing the perceived coefficient of friction of the surface associated with the haptic output device 126. In some embodiments, the ultrasonic actuator may comprise a piezo-electric material.

In some embodiments, the haptic output device 126 uses electrostatic attraction, for example by use of an electrostatic actuator, to output a haptic effect. The haptic effect may comprise a simulated texture, a simulated vibration, a stroking sensation, or a perceived change in a coefficient of friction on a surface associated with the user device 120 (e.g., the touch surface 142). In some embodiments, the electrostatic actuator may comprise a conducting layer and an insulating layer. The conducting layer may be any semiconductor or other conductive material, such as copper, aluminum, gold, or silver. The insulating layer may be glass, plastic, polymer, or any other insulating material. Furthermore, the processor 128 or the processor 102 may operate the electrostatic actuator by applying an electric signal, for example an AC signal, to the conducting layer. In some embodiments, a high-voltage amplifier may generate the AC signal. The electric signal may generate a capacitive coupling between the conducting layer and an object (e.g., a user's finger or other body part, or a stylus) near or touching the touch surface 142. Varying the levels of attraction between the object and the conducting layer can vary the haptic effect perceived by a user.

In some embodiments, the haptic output device 126 comprises a deformation device configured to output a deformation haptic effect. The deformation haptic effect may comprise raising or lowering portions of a surface associated with the user device 120. For example, the deformation haptic effect may comprise raising portions of the touch surface 142. In some embodiments, the deformation haptic effect may comprise bending, folding, rolling, twisting, squeezing, flexing, changing the shape of, or otherwise deforming a surface associated with the user device 120. For example, the deformation haptic effect may apply a force on the user device 120 or a surface associated with the user device 120 (e.g., the touch surface 142), causing it to bend, fold, roll, twist, squeeze, flex, change shape, or otherwise deform.

In some embodiments, the haptic output device 126 comprises fluid configured for outputting a deformation haptic effect (e.g., for bending or deforming a surface associated with the user device 120). For example, the fluid may comprise a smart gel. A smart gel comprises a fluid with mechanical or structural properties that change in response to a stimulus or stimuli (e.g., an electric field, a magnetic field, temperature, ultraviolet light, shaking, or a pH variation). For instance, in response to a stimulus, a smart gel may change in stiffness, volume, transparency, and/or color. In some embodiments, stiffness may comprise the resistance of a surface associated with the user device 120 (e.g., the touch surface 142) against deformation. In some embodiments, one or more wires may be embedded in or coupled to the smart gel. As current runs through the wires, heat is emitted, causing the smart gel to expand or contract, which may cause the user device 120 or a surface associated with the user device 120 to deform.

As another example, the fluid may comprise a rheological (e.g., a magneto-rheological or electro-rheological) fluid. A rheological fluid comprises metal particles (e.g., iron particles) suspended in a fluid (e.g., oil or water). In response to an electric or magnetic field, the order of the molecules in the fluid may realign, changing the overall damping and/or viscosity of the fluid. This may cause the user device 120 or a surface associated with the user device 120 to deform.

In some embodiments, the haptic output device 126 comprises a mechanical deformation device. For example, in some embodiments, the haptic output device 126 may comprise an actuator coupled to an arm that rotates a deformation component. The deformation component may comprise, for example, an oval, starburst, or corrugated shape. The deformation component may be configured to move a surface associated with the user device 120 at some rotation angles but not others. The actuator may comprise a piezo-electric actuator, rotating/linear actuator, solenoid, an electroactive polymer actuator, macro fiber composite (MFC) actuator, shape memory alloy (SMA) actuator, and/or other actuator. As the actuator rotates the deformation component, the deformation component may move the surface, causing it to deform. In such an embodiment, the deformation component may begin in a position in which the surface is flat. In response to receiving a signal from processor 128, the actuator may rotate the deformation component. Rotating the deformation component may cause one or more portions of the surface to raise or lower. The deformation component may, in some embodiments, remain in this rotated state until the processor 128 or the processor 102 signals the actuator to rotate the deformation component back to its original position.

Further, other techniques or methods can be used to deform a surface associated with the user device 120. For example, the haptic output device 126 may comprise a flexible surface layer configured to deform its surface or vary its texture based upon contact from a surface reconfigurable haptic substrate (including, but not limited to, e.g., fibers, nanotubes, electroactive polymers, piezoelectric elements, or shape memory alloys). In some embodiments, the haptic output device 126 is deformed, for example, with a deforming mechanism (e.g., a motor coupled to wires), air or fluid pockets, local deformation of materials, resonant mechanical elements, piezoelectric materials, micro-electromechanical systems (“MEMS”) elements or pumps, thermal fluid pockets, variable porosity membranes, or laminar flow modulation.

Turning to memory 132, modules 148, 150, 152, and 154 are depicted to show how a device can be configured in some embodiments to capture a user's motion and provide haptic effects based on the captured motion. In some embodiments, modules 148, 150, 152, and 154 may comprise processor executable instructions that can configure the processor 102 to perform one or more operations.

In some embodiments, a content provision module 148 includes instructions that can be executed by the processor 128 to provide content (e.g., texts, images, sounds, videos, characters, virtual objects, virtual animations, etc.) to a user (e.g., to a user of the user device 120). If the content includes computer-generated images, the content provision module 148 includes instructions that, when executed by the processor 128, cause the processor 128 to generate the images for display on a display device (e.g., the display 140 of the user device 120 or another display communicatively coupled to the processor 128). If the content includes video and/or still images, the content provision module 148 includes instructions that, when executed by the processor 128, cause the processor 128 to access the video and/or still images and generate views of the video and/or still images for display on the display 140. If the content includes audio content, the content provision module 148 includes instructions that, when executed by the processor 128, cause the processor 128 to generate electronic signals that will drive a speaker, which may be part of the display 140, to output corresponding sounds. In some embodiments, the content, or the information from which the content is derived, may be obtained by the content provision module 148 from the storage 138, which may be part of the user device 120, as illustrated in FIG. 1, or may be separate from the user device 120 and communicatively coupled to the user device 120. As an example, the content provision module 148 can cause the processor 128 to generate a simulated environment (e.g., a virtual or an augmented reality environment) for display on display 140. The simulated environment can simulate a user's physical presence and/or environment and allow the user to interact with virtual objects in the simulated environment.

In some embodiments, a motion module 150 can cause the processor 128 to receive sensor signals from the sensor 146. As an example, the motion module 150 may cause the processor 128 to receive a sensor signal from the sensor 146 when the sensor 146 detects or senses a motion of the user of the user device 120 (e.g., the user 121). In some examples, the sensor signal from the sensor 146 can include information about the user's motion including, but not limited to, a path, velocity, acceleration, or force of the user's motion, a body part of the user that is moved, and/or any other characteristic of the user's motion.

In some embodiments, the haptic effect determination module 152 can be configured in substantially the same manner as the haptic effect determination module 122, although it need not be. For example, the haptic effect determination module 152 can represent a program component that causes the processor 128 to analyze data to determine a haptic effect to generate. The haptic effect determination module 152 may comprise code that causes the processor 102 to select one or more haptic effects to output using one or more algorithms or lookup tables. In some embodiments, the haptic effect determination module 152 comprises one or more algorithms or lookup tables usable by the processor 128 to determine a haptic effect. Particularly, in some embodiments, the haptic effect determination module 152 may cause the processor 128 to determine a haptic effect based at least in part on sensor signals received from the sensor 146. For example, the sensor 146 may detect a motion of a body part of a user of the user device 120 such as, for example, the user 121, and transmit a sensor signal to the processor 128. The processor 128 may receive the sensor signal and determine the motion of the user 121 and/or a characteristic of the motion. The haptic effect determination module 122 may determine a haptic effect based at least in part on the determined user motion and/or a characteristic of the motion.

In some embodiments, the haptic effect determination module 152 can include instructions that, when executed by the processor 128, cause the processor 128 to receive a signal from the haptic effect determination module 122, which can indicate a haptic effect determined by the haptic effect determination module 122. For instance, the processor 128 can receive data from the computing device 101 that indicates a haptic effect determined based on sensor signals from the sensor 118 as described above (e.g., a haptic effect determined based on a motion of the user 119).

In another embodiment, the haptic effect determination module 152 may comprise code that causes the processor 128 to determine a haptic effect based on content provided by the content provision module 148. For example, the content provision module 148 may cause the processor 128 to provide visual content to be output via the display device 140 and the visual content can include the user 119. In one embodiment, the haptic effect determination module 152 may cause the processor 128 to determine a haptic effect associated with the visual content. For example, in one such embodiment, the haptic effect determination module 152 may cause the processor 128 to determine a haptic effect for providing a haptic track associated with a video that includes the user 119 and is being provided by the display device 140. A haptic track can include a haptic effect (e.g., a vibration) or a series of haptic effects that correspond to events occurring in the video being provided. For instance, if the video includes the user 119 moving a hand up, running and then stopping, signaling a high five, jumping, turning the user's head, etc., the haptic track can include one or more vibrations that correspond to each motion by the user 119. As another example, if the video includes a series of explosions in an environment of the user 119, the haptic track can be a series of vibrations that correspond to each explosion. Thus, in some embodiments, as the user 119 or another user 121 watches the video, the user 119 or 121 may perceive the haptic effects associated with the video.

In some embodiments, the processor 128 may determine a user's motion (e.g., gesture) and determine or modify a characteristic (e.g., a magnitude, duration, location, type, frequency, etc.) of the haptic effect based on the motion and/or characteristic of the motion. For example, in one embodiment, the haptic effect determination module 152 may cause the processor 128 to access one or more lookup tables or databases that include data corresponding to a characteristic of a haptic effect associated with a user's motion and/or characteristic of the motion. In this embodiment, the processor 128 can access the one or more lookup tables or databases and determine or modify a characteristic of one or more haptic effects associated with the user's motion or gesture and/or characteristic of the motion. For instance, the processor 128 can determine a haptic effect based on a detected motion of the user 121 (e.g., based on sensor signals from the sensor 146) and output the haptic effect to the user 121 via the haptic output device 126. In this example, the sensor 146 can also detect or sense an additional motion of the user 121 (e.g., as the user is perceiving the haptic effect) and the sensed motion can be used to determine or modify a characteristic of the haptic effect such as, for example, by increasing a magnitude of the haptic effect in response to determining that the user 121 is raising a hand as the user 121 perceives the haptic effect.

In some examples, a motion or gesture by the user 121 can be used to determine or modify characteristics of a haptic effect that is generated based on information about a motion of another user or an environment of the other user. For instance, the haptic effect determination module 152 can cause the processor 128 to receive a signal indicating a haptic effect determined by the processor 102 based on a motion of a user 119 associated with the sensor 118 or an environment of the user 119. In this example, the haptic effect determination module 152 can cause the processor 128 to determine or modify a characteristic of the haptic effect in substantially the same manner as described above. For instance, the user 119 associated with the sensor 118 is jumping up and down and the processor 102 determines a haptic effect that includes a series of strong vibrations based on determining that the user 119 is jumping up and down. In this example, the haptic effect determination module 152 causes the processor 128 to receive a signal indicating the determined haptic effect from the processor 102 and the haptic effect can be output to the user 121 via the haptic output device 126 (e.g., in substantially real time as the user 119 is jumping or at a later time). The sensor 146 can detect or sense a motion of the user 121 and the detected motion can be used to determine or modify a characteristic of the haptic effect such as, for example, by reducing a magnitude of the vibrations in response to determining that the user 121 is lowering a hand as the user 121 perceives the haptic effect. In this manner, a user perceiving a haptic effect determined based on a user's motions or environment can provide user input (e.g., additional user motions or gestures) to modify characteristics of the haptic effect.

In some embodiments, the haptic effect determination module 152 comprises code that causes the processor 128 to determine a haptic effect based on an event. An event, as used herein, is any interaction, action, collision, or other event, which occurs during operation of the user device 120, which can potentially comprise an associated haptic effect. In some embodiments, an event may comprise user input (e.g., a button press, manipulating a joystick, interacting with a touch surface 116 or touch surface 142, tilting or orienting the computing device 101 or user device 120), a system status (e.g., low battery, low memory, or a system notification, such as a notification generated based on the system receiving a message, an incoming phone call, a notification, or an update), sending data, receiving data, a program event (e.g., if the program is a game, a program event may comprise explosions, gunshots, collisions, interactions between game characters, interactions between a user and one or more elements in a simulated environment, a movement of a character in a simulated environment, etc.), or an action by a user 119 (e.g., motion of the user 119).

In some embodiments, the haptic effect determination module 152 can include instructions that, when executed by the processor 128, cause the processor 128 to receive a signal from the processor 102, which can indicate a haptic effect determined by the processor 102. For instance, the processor 128 can receive data from the processor 102 that indicates a haptic effect determined based on sensor signals from the sensor 118 as described above. In this example, the haptic effect generation module 154 can cause the processor 128 to generate and transmit haptic signals to the haptic output device 126 to generate the selected haptic effect.

In some embodiments, the haptic effect generation module 154 can be configured in substantially the same manner as the haptic effect generation module 124, although it need not be. For example, the haptic effect generation module 154 can cause the processor 128 to generate and transmit a haptic signal to the haptic output device 126 to generate a haptic effect determined by the processor 102 or the processor 128. In some embodiments, the haptic effect generation module 154 may comprise algorithms to determine target coordinates for the haptic effect (e.g., coordinates for a location at which to output the haptic effect). For example, the haptic effect generation module 154 may cause the processor 128 to use a sensor signal indicating a motion of a particular body part of the user 119 or the user 121 to determine target coordinates for the haptic effect. For instance, if the sensor 118 detects a motion of a hand of the user 119, the haptic effect generation module 154 may determine coordinates for the haptic effect such that the haptic effect is output to the hand of the user 121. In some embodiments, the haptic output device 126 may include one or more haptic output devices. In such embodiments, the haptic effect generation module 154 or the haptic effect generation module 124 may cause the processor 128 or processor 102 to transmit haptic signals to the one or more haptic output devices to generate the selected haptic effect.

In some examples, the haptic effect generation module 124 or haptic effect generation module 154 can cause the processor 128 or processor 102 to transmit haptic signals to the haptic output device 126 in response to determining that the content is being output, and user 121 is viewing or otherwise experiencing content that includes the user 119. For instance, the user 119 is climbing a mountain and wearing the sensor 118 that transmits one or more sensor signals indicating information about the motion of the user 119 or any information about the environment of the user 119 to the processor 102 or processor 128. In this example, the user 121 can view or experience the content that is output (e.g., a video stream or virtual reality sequence) that includes the user 119 as the user 119 climbs the mountain (e.g., in real time or at any other time). For example, the content provision module 148 can cause the processor 128 to generate images of the user 119 climbing the mountain and output the images via the display 140. Continuing with this example, the haptic effect generation module 124 or haptic effect generation module 154 can cause the processor 128 or processor 102 to transmit haptic signals to the haptic output device 126 as the user 121 watches or experiences the first user 119 climbing the mountain. The haptic output device 126 can output a haptic effect or haptic track to the user 121 in response to receiving the haptic signal, which can allow the second user 121 to perceive or experience the first user's motion, activity, or environment as the first user climbs the mountain.

In some examples, the haptic effect generation module 124 or haptic effect generation module 154 can cause the processor 128 or processor 102 to transmit haptic signals to the haptic output device 126 in response to determining that a motion or gesture by the user 121 of the user device 120 corresponds to a motion or gesture of the user 119 associated with the sensor 118. For instance, the user 119 can raise a hand and the processor 102 can determine a haptic effect associated with the user 119 raising a hand. In this example, the haptic effect determination module 152 can cause the processor 128 to receive a signal from the processor 102 that indicates the haptic effect determined by the processor 102. In this example, the processor 128 can receive sensor signals from the sensor 146 indicating a detected motion or gesture by the user 121. The processor 128 can compare the motions or gestures of the user 121 to data indicating that the haptic effect was determined based on the user 119 raising a hand to determine whether the motion or gesture by the user 121 corresponds to the user 121 raising a hand. In this example, the processor 128 can transmit haptic signals to the haptic output device 126 in response to determining that the motion or gesture by the user 121 corresponds to a detected gesture or motion used by the processor 102 to generate a haptic effect (e.g., in response to determining that the user 121 raised a hand).

Although the exemplary system 100 of FIG. 1 is depicted as having a certain number of components, in other embodiments, the exemplary system 100 has any number of additional or alternative components. Further, while FIG. 1 illustrates a particular arrangement of the computing device 101, the sensor 118, and the user device 120, various additional arrangements are possible. As an example, while FIG. 1 illustrates the sensor 118 and the computing device 101 as being separate, in some embodiments, the computing device 101 and the sensor 118 are part of a single system. For instance, the computing device 101 may include the sensor 118. As another example, while FIG. 1 illustrates the computing device 101 and the user device 120 and their respective components as being separate, in some embodiments, the computing device 101 and the user device 120 or their respective components can be part of a single system or part of any number of separate systems.

### Illustrative Methods for Capturing a User's Motion and Providing Haptic Effects Based on the Captured Motion

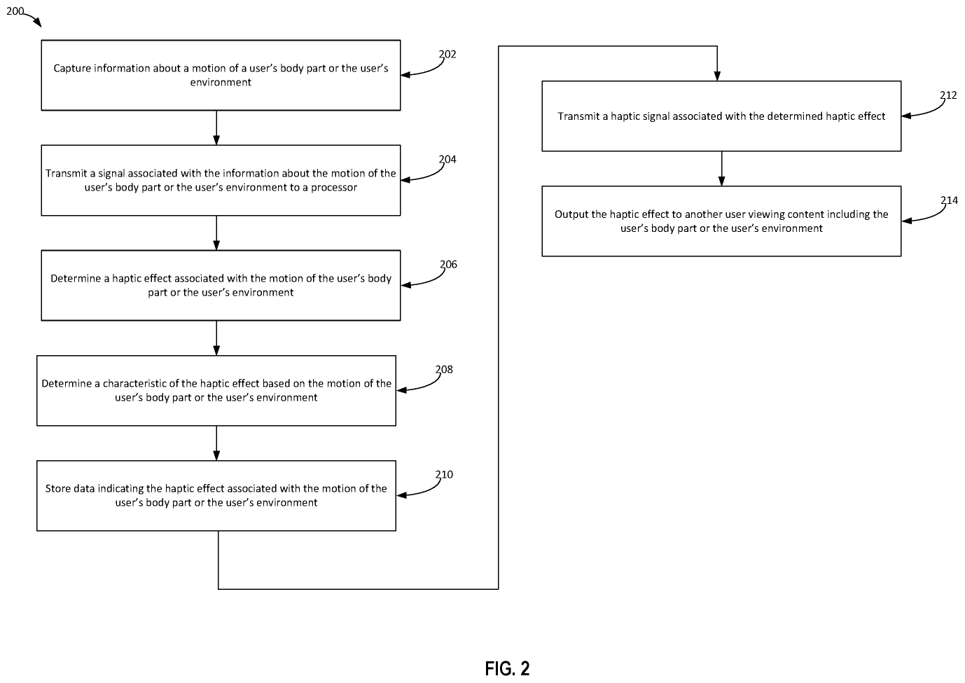

FIG. 2 is a flow chart of steps for performing a method 200 for capturing information about a user's motion or about the user's environment and providing haptic effects based on the user's motion or environment according to one embodiment. In some embodiments, the steps in FIG. 2 may be implemented in program code that is executable by a processor, for example, the processor in a general purpose computer, a mobile device, or a server. In some embodiments, these steps may be implemented by a group of processors. In some embodiments, one or more steps shown in FIG. 2 may be omitted or performed in a different order. Similarly, in some embodiments, additional steps not shown in FIG. 2 may also be performed. For illustrative purposes, the steps of the method 200 are described below with reference to components described above with regard to the system shown in FIG. 1, but other implementations are possible.

The method 200 begins at step 202 when information about a motion of a body part of a user 119 or an environment of the user 119 is captured. For example, a sensor 118 can be wearable sensor, a handheld sensor, or any sensor that can be coupled (e.g., attached) to the user 119 or otherwise associated with the user 119 to capture information about the user's motions (e.g., a motion of the user's body part) or capture information about the user's environment.

In some examples, the sensor 118 can capture information about the user's motion including, but not limited to, a path, velocity, acceleration, or force of the user's motion, a body part of the user 119 that is moved, and/or any other characteristic of the user's motion. In some examples, the sensor 118 can capture information about a parameter of the user's environment such as, for example, a temperature, humidity, latitude, etc. of the user's environment.

The method 200 continues at step 204 when a signal associated with the information about the motion of the user's body part or about the user's environment is transmitted to a processor 102. In some embodiments, the sensor 118 transmits the signal associated with the information about the motion of the body part of the user 119 or the environment of the user 119 to the processor 102. The signal can indicate a path, velocity, acceleration, or force of the user's motion, a body part of the user 119 that is moved, and/or any other characteristic of the user's motion. The signal can additionally or alternatively indicate a temperature, humidity, latitude, or other information about the environment of the user 119. In some examples, the processor 102 can receive one or more sensor signals from the sensor 118 and determine information about the user's motion or about the user's environment based on the sensor signals. The motion is captured at a time that is associated with a content. For example, the motion may be captured during recording, generation, or playback of video, virtual reality, or augmented reality content. By associating the motion with a time in the content, a later-generated haptic effect can also be associated with that same time. The time may, for example, correspond to a timestamp created in or existing in the content or to sub component of the content, such as a frame.

The method continues at step 206 when the processor 102 determines a haptic effect associated with the motion of the user's body part or about the user's environment. In some examples, a haptic effect determination module 122 causes the processor 102 to determine the haptic effect. In some embodiments, the haptic effect can include one or more haptic effects.

For example, the processor 102 can determine a haptic effect (e.g., one or more vibrations) based at least in part on a signal received from the sensor 118 (e.g., in step 204). As an example, a sensor signal may indicate a motion of a body part of the user 119 such as, for example, that the user 119 is moving a hand up, running, signaling a high five, jumping up and down, etc. The processor 102 may receive the sensor signal and access one or more lookup tables or databases that include data corresponding to various signals (e.g., various motions of various body parts), along with data indicating one or more haptic effects associated with the one or more sensor signals. The processor 102 can select from the lookup table or database a haptic effect that corresponds to the motion of the user's body part. For example, in response to the user 119 jumping up and down, the processor 102 can select a haptic effect that includes a series of vibrations and the series of vibrations can be output to a user (e.g., the user 121).

As another example, a sensor signal from the sensor 118 indicates information about the user's environment such as, for example, that the user 119 is in an environment with heavy rain, an environment with a rough terrain, etc. The processor 102 may receive the sensor signal and access one or more lookup tables or databases that include data corresponding to various haptic effects associated with various environmental conditions. The processor 102 can select from the lookup table or database a haptic effect that corresponds to the information about the user's environment. For example, in response to determining that the user 119 is in an environment with heavy rain, the processor 102 can select a haptic effect that includes a strong vibration or a series of strong vibrations that can be output to a user (e.g., the user 121).

In some examples, the sensor 118 can capture information about the motion of body parts of the user 119 or the environment of the user 119 over a period of time and transmit one or more sensor signals to the processor 102 indicating the detected user motions or information about the environment. The processor 102 can determine one or more haptic effects associated with the various user motions or about the user's environment over the period of time. In this example, the processor 102 can receive signals from the sensor 118 indicating a time stamp corresponding to a time that each user motion is captured or information about the user's environment is captured and the processor 102 can determine a timeline that indicates an order of the various user motions or environmental conditions over the period of time. The processor 102 can determine a haptic effect associated with each detected user motion or environmental condition in the timeline and transmit a haptic signal associated with each haptic effect (e.g., in step 212 described below) to a haptic output device 126. In this example, the haptic output device 126 can output the haptic effects to a user (e.g., in step 214) such that the user perceives the haptic effects based on the timeline (e.g., perceives a haptic effect associated with each detected motion or environmental condition based on the order of the user motions or environmental conditions in the timeline).

In some embodiments, in step 206, the processor 102 can determine a haptic effect associated with a simulated motion of the user's body part. For instance, the user 119 may not move a body part and the processor 102 may receive or determine data indicating a simulated motion of the user's body part or a characteristic of the simulated motion of the user's body part. For example, the processor 102 can receive (e.g., obtain) data indicating simulated force, velocity, or acceleration parameters associated with the user 119 jumping up and down (e.g., simulated parameters based on previously measured parameters associated with another person jumping up and down). In this example, the parameters can be based on historical data obtained from a person jumping up and down or a simulation of a person jumping up and down. In this example, the processor 102 can determine one or more haptic effects associated with the simulated motion of the user's body part in substantially the same manner as described above. For instance, the processor 102 may receive data indicating a simulated motion of the user's body part and access one or more lookup tables or databases that include data corresponding to various simulated motions of the user's body part, along with data indicating one or more haptic effects associated with the one or more simulated motions of the user's body part. The processor 102 can select from the lookup table or database a haptic effect that corresponds to the simulated motion of the user's body part. For example, the processor 102 can receive data indicating simulated force, acceleration, or velocity parameters associated with a person running fast and the processor 102 can select a haptic effect that includes a series of vibrations that can be output to a user (e.g., the user 121).

In another example, in step 206, the processor 102 can determine a haptic effect associated with a simulated environment with which the user 119 is interacting. For instance, the user 119 may interact with a simulated environment (e.g., a virtual or augmented reality environment) and the conditions of the simulated environment may be different from the conditions of the user's physical environment (e.g., a room in which the user 119 is positioned). In this example, the processor 102 can receive data indicating parameters (e.g., characteristics) or conditions of the simulated environment and the processor 102 can determine one or more haptic effects associated with the parameters or conditions of the simulated environment. For instance, the processor 102 may receive data indicating environmental conditions of an augmented or virtual reality environment with which the user 119 is interacting. The processor 102 can access one or more lookup tables or databases that include data corresponding to simulated environmental conditions, along with data indicating one or more haptic effects associated with the one or more simulated environmental conditions. The processor 102 can select from the lookup table or database a haptic effect that corresponds to the environmental conditions of the augmented or virtual reality environment. For example, the processor 102 can receive data indicating that the user 119 is interacting with a virtual reality environment that includes simulated or virtual rain and the processor 102 can select a haptic effect that includes a series of vibrations that can be output to a user (e.g., the user 121).

In some embodiments, in step 206, the processor 102 can determine a first haptic effect based on the motion of the body part of the user 119 and a second haptic effect based on the environment of the user 119. In still another example, the processor 102 can determine a single haptic effect based on the motion of the user's body part and the user's environment.

In some embodiments, in step 206, the processor 102 may determine one or more haptic output devices 126 to actuate, in order to generate or output the determined haptic effect. For example, a signal received from the sensor 118 may indicate the body part of the user 119 that is moved (e.g., in step 202) and the processor 102 can access a lookup table that includes data corresponding to various haptic effects, along with data corresponding to various haptic output devices 126 for outputting each haptic effect and a location of each haptic output device 126. The processor 102 can select a haptic effect or a haptic output device 126 from the lookup table or database to output the haptic effect based on the body part of the user 119 that is moved. For instance, the sensor 118 can detect or sense that the user 119 is clapping and transmit signals to the processor 102, which can access the lookup table and determine a haptic effect associated with the user 119 clapping. In this example, the processor 102 can select a haptic output device 126 from the lookup table to output a haptic effect to a user's hands (e.g., the hands of the user 119 or the user 121).

The method continues at step 208 when the processor 102 determines a characteristic (e.g., a magnitude, duration, location, type, frequency, etc.) of the haptic effect based at least in part on the motion of the body part of the user 119 or the environment of the user 119. In some examples, the haptic effect determination module 122 causes the processor 102 to determine the characteristic of the haptic effect. As an example, the processor 102 can determine that the user 119 is running at a slow pace based on the sensor signal received from the sensor 118 (e.g., in step 204). Based on this determination, the processor 102 can determine a weak or short haptic effect (e.g., vibration). As another example, the processor 102 can determine that the user 119 is in an environment with heavy rainfall and the processor 102 can determine a strong or long haptic effect based on this determination.

In some embodiments, in step 208, the processor 102 can determine a characteristic of the haptic effect based at least in part on a simulated motion of the user's body part or about the user's simulated environment in substantially the same manner as described above.

The method 200 continues at step 210 when the processor 102 stores data indicating the determined haptic effect. In some embodiments, the processor 102 can store data indicating the determined haptic effect in a storage or database (e.g., the storage 112 or the storage 138), along with data about the user's motion or environment associated with the haptic effect.

The method 200 continues at step 212 when the processor 102 transmits a haptic signal associated with the haptic effect to a haptic output device 126. In some embodiments, the haptic effect generation module 124 causes the processor 102 to generate and transmit the haptic signal to the haptic output device 126.

The method 200 continues at step 214 when the haptic output device 126 outputs the haptic effect. In some embodiments, the haptic output device 126 receives the haptic signal from the processor 102 and outputs the haptic output effect to a user associated with a user device 120 based on the haptic signal. For instance, the haptic output device 126 can output the haptic effect to the user 121 associated with the user device 120 (e.g., a user holding, wearing, using, or otherwise associated with the user device 120). In some embodiments, the haptic output device 126 can receive the haptic signal in substantially real time (e.g., as the sensor 118 captures information about a motion of a body part of the user 119 or the environment of the user 119 in step 202) such that the haptic output device 126 can output the haptic effect in substantially real time. In another embodiment, the determined haptic effects can be stored (e.g., in step 210) and output via the haptic output device 126 subsequently. In some embodiments, the haptic output device 126 can receive the haptic signal and output the haptic effect to the user 121 as the user 121 perceives or views the motion of the body part of the user 119 or the environment of the user 119.

As an illustrative example, a first user 119 is running through a rainforest and wearing a sensor 118 that senses or detects information about the first user's motion, activity, or any information about the environment surrounding the first user 119. The sensor 118 can transmit various sensor signals about the first user's motion, activity, or environment to the processor 102 that determines one or more haptic effects based on the sensor signals from the sensor 118. In this example, the processor 102 can transmit haptic signals to the haptic output device 126 associated with a second user 121 that is remote from the first user 119 (e.g., to a user device 120 worn or held by the second user 121 that includes the haptic output device 126). In this illustrative example, the second user 121 can be watching content that includes the first user 119 as the first user 119 runs through the rainforest via the display device 140 (e.g., in real time or at a later time) and the haptic output device 126 can output one or more haptic effects as the second user 121 views the motion of the first user 119 or the environment of the first user 119, which can allow the second user 121 to perceive or experience the first user's motion, activity, or surrounding environment as the first user 119 runs though the rainforest.

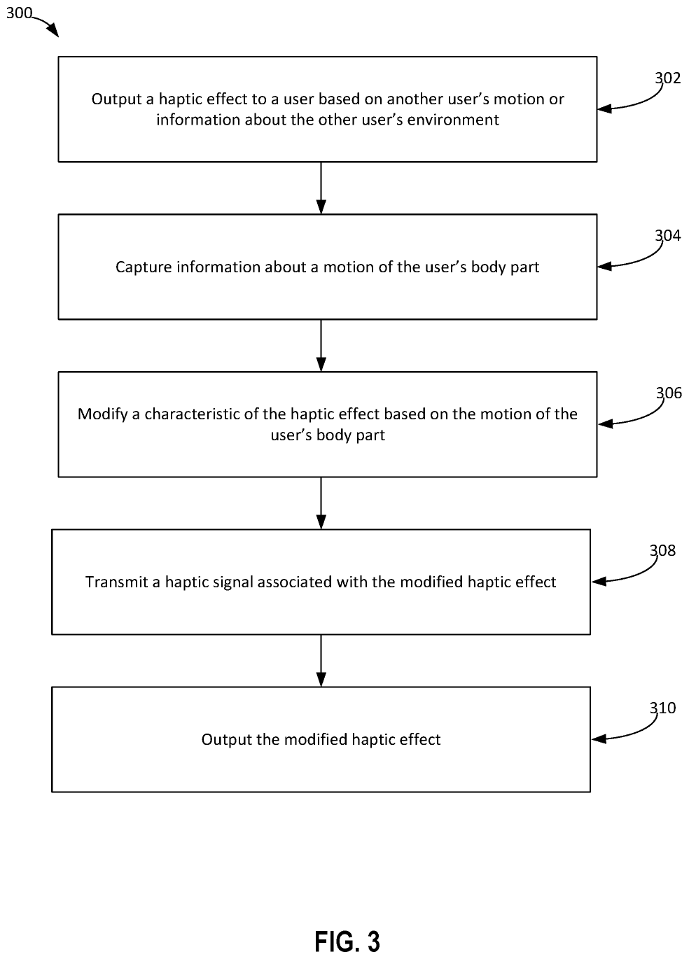

FIG. 3 is a flow chart of steps for performing a method 300 for capturing information about a user's motion and providing haptic effects based on the user's motion according to another embodiment. In some embodiments, the steps in FIG. 3 may be implemented in program code that is executable by a processor, for example, the processor in a general purpose computer, a mobile device, or a server. In some embodiments, these steps may be implemented by a group of processors. In some embodiments, one or more steps shown in FIG. 3 may be omitted or performed in a different order. Similarly, in some embodiments, additional steps not shown in FIG. 3 may also be performed. For illustrative purposes, the steps of the method 300 are described below with reference to components described above with regard to the system shown in FIG. 1, but other implementations are possible.

The method 300 begins at step 302 when a haptic effect is output to a user 121 based on another user's motion or information about the other user's environment. For example, a haptic output device 126 can receive a haptic signal associated with a haptic effect (e.g., from the processor 102). The haptic effect can be determined based on a motion of one or more users or an environment of the one or more users. For instance, the haptic effect can be determined based on a motion of a user 119 or an environment of the user 119. As an example, a processor 102 can determine a haptic effect based on sensor signals indicating a motion of a body part of the user 119 or information about an environment of the user 119 (e.g., in step 206 of FIG. 2). As another example, a processor 128 can determine a haptic effect based on sensor signals indicating a motion of a body part of the user 121 in substantially the same manner as described above. The haptic output device 126 can receive a haptic signal associated with a determined haptic effect and output a haptic effect to the user 121 in response to receiving the haptic signal. In some examples, the haptic output device 126 can receive a haptic signal associated with a determined haptic effect as the user 121 views or experiences content that includes the other user. For example, the haptic output device 126 can receive a haptic signal associated with a determined haptic effect or haptic track based on a motion of the user 119 as the user 121 watches the motion of the user 119.

The method 300 continues at step 304 when information about a motion of a body part of the user 121 is captured. For example, a user device 120 can be a computing device (e.g., a smartwatch) that includes a sensor 146. The sensor 146 can be any sensor that can capture information about a motion of a body part of the user 121. In some examples, the sensor 146 can capture information about the user's motion including, but not limited to, a path, velocity, acceleration, or force of the user's motion, a body part of the user 121 that is moved, and/or any other characteristic of the user's motion.

The method 300 continues at step 306 when a characteristic (e.g., a magnitude, duration, location, type, frequency, etc.) of the haptic effect is modified based on the motion of the user's body part (e.g., the motion captured in step 304). For example, a motion or gesture by the user 121 can be used to determine or modify characteristics of the haptic effect. As an example, the haptic output device 126 receives a haptic signal from the processor 102 based on the user 119 jumping up and down and the haptic output device 126 outputs a series of strong vibrations to the user 121 in response to receiving the haptic signal. In this example, the sensor 146 can detect or sense a motion of the user 121 as the user 121 perceives the haptic effect and the detected motion can be used to determine or modify a characteristic of the haptic effect. For example, the processor 128 can receive sensor signals from the sensor 146 and reduce a magnitude of the vibrations in response to determining that the user 121 is lowering a hand as the user 121 perceives the haptic effect.

In some embodiments, in step 306, the user 121 can provide any user input to modify a characteristic of the haptic effect. For instance, the user 121 can provide user input (e.g., via a motion of a body part of the user 121 or other user input) to modify a location of the haptic effect. As an example, the haptic effect can be based on a captured motion of a body part of the user 119 and the haptic output device 126 can receive a haptic signal indicating that the haptic effect is to be output to a corresponding body part of the user 121. In this example, the user 121 can provide user input to modify a location of the haptic effect. For instance, the haptic effect can be determined based on sensor signals indicating that the user 119 is clapping and the haptic output device 126 can receive a haptic signal indicating that the haptic effect is to be output at a corresponding body part of the user 121 (e.g., output to the hands of the user 121). In this example, the user 121 can provide user input to modify a location of the haptic effect such as, for example, by raising a leg, and the processor 128 can receive sensor signals from the sensor 146 and modify the location of the haptic effect such that the haptic effect is output to the leg of the user 121.

The method 300 continues at step 308 when the processor 128 transmits a haptic signal associated with the modified haptic effect to the haptic output device 126. In some embodiments, the haptic effect generation module 154 causes the processor 128 to generate and transmit the haptic signal to the haptic output device 126.

The method 300 continues at step 310 when the haptic output device 126 outputs the modified haptic effect. In some embodiments, the haptic output device 126 receives the haptic signal from the processor 128 and outputs the modified haptic output effect to the user 121. As an example, the processor 128 can modify a characteristic of the haptic effect (e.g., in step 306) and transmit a haptic signal associated with the modified haptic effect to the haptic output device 126 and the haptic output device 126 can output the modified haptic effect.

In this manner, the systems and methods described herein can capture information about a user's motions and generate or modify a haptic effect based on the motion.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may comprise computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A system comprising:
a first sensor configured to capture a motion of a first user;
a processor communicatively coupled to the first sensor and configured to:
receive, from the first sensor, a first sensor signal indicating the motion of the first user at a time associated with a content;
determine a first haptic effect associated with the motion of the first user; and
transmit a first haptic signal associated with the first haptic effect to be output at the time associated with the content during output of the content; and
a haptic output device configured to
receive the first haptic signal and output the first haptic effect.

2. The system of claim 1, further comprising:
a second sensor configured to capture information indicating a motion of a second user, wherein the processor is communicatively coupled to the second sensor and the processor is further configured to:
receive, from the second sensor, a second sensor signal indicating the motion of the second user; and
determine a characteristic of the first haptic effect based on the motion of the second user.

3. The system of claim 1, further comprising:
a second sensor configured to capture information indicating a motion of a second user, wherein the processor is communicatively coupled to the second sensor and the processor is further configured to:
receive, from the second sensor, a second sensor signal indicating the motion of the second user;
compare the motion of the second user to the motion of the first user; and
transmit the first haptic signal associated with the first haptic effect in response to determining that the motion of the second user corresponds to the motion of the first user.

4. The system of claim 1, wherein the first sensor is further configured to capture information indicating a parameter of the first user's environment and wherein the processor is further configured to:
receive, from the first sensor, a second sensor signal indicating the parameter of the first user's environment;
determine a second haptic effect associated with the parameter of the first user's environment; and
transmit a second haptic signal associated with the second haptic effect, and wherein the haptic output device is configured to receive the second haptic signal and output the second haptic effect based on the parameter of the first user's environment.

5. The system of claim 1, wherein the processor is further configured to:
receive data indicating a simulated motion of the first user; and
determine the first haptic effect based on the simulated motion of the first user.

6. The system of claim 1, wherein the processor is further configured to:
receive data indicating a parameter of a simulated environment with which the first user is interacting; and
determine the first haptic effect based on the parameter of the simulated environment.

7. The system of claim 1, wherein the content comprises one of video content, virtual reality content, or augmented reality content.

8. A method comprising:
capturing, by a first sensor, information indicating a first motion of a first user and a second motion of the first user at a time associated with a content;
receiving, by a processor, a first signal indicating the first motion of the first user;
determining, by the processor, a first haptic effect associated with the first motion of the first user based on the first signal;
determining, by the processor, a characteristic of the first haptic effect based on the second motion of the first user; and
transmitting, by the processor, a haptic signal associated with the first haptic effect to be output at the time associated with the content during output of the content to a haptic output device.

9. The method of claim 8, further comprising outputting, by the haptic output device, the first haptic effect at the time associated with the content during output of the content.

10. The method of claim 8, wherein the content comprises one of video content, virtual reality content, or augmented reality content.

11. The method of claim 8, further comprising:
capturing, by a second sensor, information indicating a motion of a second user;
receiving, by the processor, a second sensor signal indicating the motion of the second user from the second sensor;
comparing, by the processor, the motion of the second user to the motion of the first user; and
transmitting, by the processor, the haptic signal associated with the first haptic effect in response to determining that the motion of the second user corresponds to the motion of the first user.

12. The method of claim 8, further comprising:
capturing, by the first sensor, information indicating a parameter of an environment of the first user;
determining, by the processor, a second haptic effect associated with the parameter of the first user's environment;
transmitting, by the processor, a haptic signal associated with the second haptic effect;
receiving, by the haptic output device, the haptic signal associated with the second haptic effect; and
outputting, by the haptic output device, the second haptic effect based on the parameter of the first user's environment.

13. The method of claim 8, further comprising:
receiving, by the processor, data indicating a simulated motion of the first user; and
determining, by the processor, the first haptic effect based on the simulated motion of the first user.

14. The method of claim 8, further comprising:
receiving, by the processor, data indicating a parameter of a simulated environment with which the first user is interacting; and
determining, by the processor, the first haptic effect based on the parameter of the simulated environment.

15. A system comprising:
a first sensor configured to capture information indicating a motion of a first user's body part;
a second sensor configured to capture information indicating a motion of a second user's body part;
a processor communicatively coupled to the first sensor and the second sensor, the processor configured to:
receive, from the first sensor, a first sensor signal indicating the motion of the first user's body part;
determine a first haptic effect associated with the motion of the first user's body part;
receive, from the second sensor, a second sensor signal indicating the motion of the second user's body part;
determine a characteristic of the first haptic effect based on the motion of the second user's body part; and
transmit a haptic signal associated with the first haptic effect; and
a haptic output device configured to receive the haptic signal and output the first haptic effect.

16. The system of claim 15, wherein the haptic output device is associated with the second user and is further configured to output the first haptic effect to the second user based on the motion of the first user's body part.

17. The system of claim 15, wherein the processor is further configured to:
compare the motion of the second user's body part to the motion of the first user's body part; and
transmit the haptic signal associated with the first haptic effect in response to determining that the motion of the second user's body part corresponds to the motion of the first user's body part.

18. The system of claim 15, wherein the first sensor is further configured to capture information indicating a parameter of an environment of the first user and wherein the processor is further configured to:
receive, from the first sensor, a third sensor signal indicating the parameter of the first user's environment;
determine a second haptic effect associated with the parameter of the first user's environment; and
transmit a haptic signal associated with the second haptic effect, and wherein the haptic output device is configured to receive the haptic signal and output the second haptic effect based on the parameter of the first user's environment.

19. The system of claim 18, wherein the processor is further configured to:
determine a characteristic of the second haptic effect based on the motion of the second user's body part.

20. The system of claim 18, wherein the processor is further configured to:
receive data indicating a simulated motion of the first user's body part or a parameter of a simulated environment with which the first user is interacting; and
determine the first haptic effect based on the simulated motion of the first user's body part or the parameter of the simulated environment.
